(19) United States
(12) Patent Application Publication
(10) Pub. No.: US 2026/0225556 A1
(43) Pub. Date: Aug. 6, 2026

(54) SEAT BELT RETRACTOR

(71) Applicant: ASHIMORI INDUSTRY CO., LTD., Osaka (JP)

(72) Inventors: Taro YOKOYAMA, Osaka (JP); Eri FUJIWARA, Osaka (JP); Daiki HIJIKATA, Osaka (JP)

(21) Appl. No.: 19/460,882

(22) Filed: Jan. 27, 2026

(30) Foreign Application Priority Data
Jan. 31, 2025 (JP) 2025-015522

(51) Int. Cl. B60R 22/46; B60R 22/28

(52) U.S. Cl. CPC B60R 22/4676; B60R 2022/286

(57) ABSTRACT

A seat belt retractor includes a housing, a winding drum, a holding member, a locking base, an impact energy absorbing member, an impact energy absorbing wire, and a cap member. The impact energy absorbing wire is received in a slot of the winding drum. The cap member is mounted on the holding member or the winding drum. The impact energy absorbing wire includes a head portion extending through the holding member in an axial direction of the winding drum. The cap member includes a cover portion configured to contact the head portion of the impact energy absorbing wire to prevent the impact energy absorbing wire from being displaced from the slot.

### CROSS-REFERENCE TO RELATED APPLICATION

This application claims priority to and the benefit of Japanese Patent Application No. 2025-015522, filed on January 31, 2025, the entire disclosure of which is incorporated herein by reference.

### BACKGROUND ART

### FIELD OF THE INVENTION

The present disclosure relates to a seat belt retractor capable of absorbing impact energy applied to a vehicle occupant in an emergency such as a vehicle collision while allowing a webbing to be pulled out

### DESCRIPTION OF THE RELATED ART

A seat belt retractor that prevents pull-out of a webbing in a vehicle emergency is conventionally known. In such a seat belt retractor, a winding drum on which the webbing is wound is rotatably mounted between a pair of side walls of a housing.

For example, Japanese Laid-Open Patent Application Publication No. 2020-104777 discloses a seat belt retractor 100 as shown in FIG. 21. The seat belt retractor 100 is capable of absorbing impact energy applied to a vehicle occupant in a vehicle emergency while allowing a webbing 200 to be pulled out, and capable of restricting the pull-out amount of the webbing 200.

Specifically, the seat belt retractor 100 of Japanese Laid-Open Patent Application Publication No. 2020-104777 includes a housing 110 having side walls 111 and 112, and a winding drum 120, and further includes a torsion bar 130 serving as an impact energy absorbing member, an impact energy absorbing wire 140, a stopper member 150, a locking base 160, and a lock mechanism 170. In Japanese Laid-Open Patent Application Publication No. 2020-104777, the “housing” is referred to as a “frame”, the “winding drum” is referred to as a “spool”, and the “impact energy absorbing wire” is referred to as an “EA pin”. The locking base 160 and the lock mechanism 170 are collectively referred to as “lock means”.

The torsion bar 130 is inserted in a central hole 121 of the winding drum 120. Under normal states, the torsion bar 130 connects the winding drum 120 and the locking base 160 such that they are rotatable together. In a vehicle emergency, the torsion bar 130 plastically deforms to absorb impact energy while permitting relative rotation between the winding drum 120 and the locking base 160. In a vehicle emergency, the locking base 160 is prevented by the lock mechanism 170 from rotating in the pull-out direction.

The impact energy absorbing wire 140 is received in a slot 122 of the winding drum 120. The impact energy absorbing wire 140 includes a head portion extending through, and attached to, the locking base 160. During relative rotation between the winding drum 120 and the locking base 160, the impact energy absorbing wire 140 is pulled out from an opening of the slot 122 while plastically deforming, thereby absorbing impact energy.

The locking base 160 includes a disc-shaped main body portion 161 and a shaft portion 162 projecting from the main body portion 161 into the central hole 121 of the winding drum 120. The shaft portion 162 includes a male thread formed on the outer peripheral surface of its distal portion, and the stopper member 150 is screwed on to the male thread. The stopper member 150 rotates together with the winding drum 120, and defines the allowable amount of relative rotation between the winding drum 120 and the locking base 160 during impact energy absorption by the torsion bar 130. In other words, the stopper member 150 defines the pull-out amount of the webbing 200 during impact energy absorption. To be more specific, during relative rotation between the winding drum 120 and the locking base 160, the stopper member 150 moves from an initial position to a position where it contacts a stepped portion of the shaft portion 162 of the locking base 160, thereby limiting the relative rotation between the winding drum 120 and the locking base 160 to a predetermined amount.

### SUMMARY OF THE INVENTION

In the seat belt retractor 100 of Japanese Laid-Open Patent Application Publication No. 2020-104777, a retainer portion of the head portion of the impact energy absorbing wire 140 is normally fitted within a recess of the locking base 160 to prevent the head portion of the impact energy absorbing wire 140 from protruding out of the surface of the locking base 160. However, when the seat belt retractor 100 is in use, the impact energy absorbing wire 140 might be displaced from the slot 122 of the winding drum 120 due to vibration, causing the head portion of the impact energy absorbing wire 140 to protrude out of the surface of the locking base 160. In such a case, the head portion of the impact energy absorbing wire 140 might interfere with the lock mechanism 170 and adversely affect the operation of the lock mechanism 170.

Depending on the structure of the seat belt retractor, the head portion of the impact energy absorbing wire may adversely affect the operation of a pretensioner in case that the impact energy absorbing wire is displaced from the slot of the winding drum.

An aspect of non-limiting embodiments of the present disclosure relates to providing a seat belt retractor capable of reliably retaining an impact energy absorbing wire in a slot of a winding drum.

A first aspect of the present disclosure provides a seat belt retractor, the seat belt retractor including: a housing including a pair of opposed side walls; a winding drum on which a webbing is wound, the winding drum being located between the pair of side walls and rotatable in a winding direction for winding of the webbing and in a pull-out direction for pull-out of the webbing; a holding member located in a first axial direction relative to the winding drum and rotatable relative to the winding drum, the first axial direction being one of opposite axial directions of the winding drum; a locking base mounted on the holding member, rotatable together with the holding member, and configured to be prevented from rotating in the pull-out direction in a vehicle emergency; an impact energy absorbing member including a first end and a second end, coupled to the winding drum at or near the first end and to the locking base at or near the second end, and configured to, under a normal state, connect the winding drum and the locking base such that the winding drum and the locking base are rotatable together, the impact energy absorbing member being further configured to, in case that a pull-out force applied to the webbing exceeds a predetermined level while rotation of the locking base in the pull-out direction is prevented, plastically deform to absorb impact energy while permitting relative rotation between the winding drum and the locking base; an impact energy absorbing wire received in a slot located in the winding drum, the slot having an opening facing in the first axial direction, the impact energy absorbing wire including a head portion protruding from the opening of the slot and attached to the holding member, the impact energy absorbing wire being configured to, during relative rotation between the winding drum and the locking base, be pulled out from the opening of the slot while plastically deforming to absorb impact energy; and a cap member mounted on the holding member or the winding drum, wherein the head portion of the impact energy absorbing wire extends through the holding member in a second axial direction opposite to the first axial direction, and the cap member includes a cover portion configured to contact the head portion of the impact energy absorbing wire to prevent the impact energy absorbing wire from being displaced from the slot.

A second aspect of the present disclosure provides a seat belt retractor, the seat belt retractor including: a housing including a pair of opposed side walls; a winding drum on which a webbing is wound, the winding drum being located between the pair of side walls and rotatable in a winding direction for winding of the webbing and in a pull-out direction for pull-out of the webbing; a locking base located in a first axial direction relative to the winding drum, the first axial direction being one of opposite axial directions of the winding drum, the locking base being configured to be prevented from rotating in the pull-out direction in a vehicle emergency; an impact energy absorbing member including a first end and a second end, coupled to the winding drum at or near the first end and to the locking base at or near the second end, and configured to, under a normal state, connect the winding drum and the locking base such that the winding drum and the locking base are rotatable together, the impact energy absorbing member being further configured to, in case that a pull-out force applied to the webbing exceeds a predetermined level while rotation of the locking base in the pull-out direction is prevented, plastically deform to absorb impact energy while permitting relative rotation between the winding drum and the locking base; an impact energy absorbing wire received in a slot located in the winding drum, the slot having an opening facing in the first axial direction, the impact energy absorbing wire including a head portion protruding from the opening of the slot and attached to the locking base, the impact energy absorbing wire being configured to, during relative rotation between the winding drum and the locking base, be pulled out from the opening of the slot while plastically deforming to absorb impact energy; and a cap member mounted on the locking base or the winding drum, wherein the head portion of the impact energy absorbing wire extends through the locking base in a second axial direction opposite to the first axial direction, and the cap member includes a cover portion configured to contact the head portion of the impact energy absorbing wire to prevent the impact energy absorbing wire from being displaced from the slot.

### BRIEF DESCRIPTION OF THE DRAWINGS

FIG. 1 is a perspective view of a seat belt retractor according to one embodiment.

FIG. 2 is an exploded perspective view of the seat belt retractor shown in FIG. 1.

FIG. 3 is a cross-sectional view of the seat belt retractor shown in FIG. 1.

FIG. 4 is a cross-sectional view of a winding drum unit.

FIG. 5 is an exploded perspective view of some components of the winding drum unit.

FIG. 6 is an exploded perspective view of other components of the winding drum unit.

FIG. 7 is an exploded perspective view of further components of the winding drum unit and a synchronized gear.

FIG. 8 is a perspective view of a winding drum.

FIG. 9 is a perspective view of a bush.

FIG. 10 is a perspective view showing the winding drum, the bush, and a stopper member in cross-section to illustrate the winding drum with the bush, the stopper member, and an impact energy absorbing wire mounted thereon.

FIG. 11 is a perspective view of a holding member and a ring member.

FIG. 12 is an exploded perspective view of a locking base and a lock member.

FIG. 13 is an exploded perspective view of the locking base and the lock member as viewed in a direction opposite to that of FIG. 12.

FIG. 14 is a side view showing a return spring, with the lock member in a non-engagement position.

FIG. 15 is a side view showing the return spring, with the lock member in an engagement position.

FIG. 16 is an enlarged view of a principal part of FIG. 4.

FIG. 17 is an exploded perspective view of a cap member and a winding drum with the ring member, the holding member, and the impact energy absorbing wire mounted thereon.

FIG. 18 is a cross-sectional view of a principal part of a winding drum unit according to a first modification.

FIG. 19 is a cross-sectional view of a principal part of a winding drum unit according to a second modification.

FIG. 20 is a cross-sectional view of a winding drum unit according to a third modification.

FIG. 21 is a front view showing a part of a conventional seat belt retractor in cross-section.

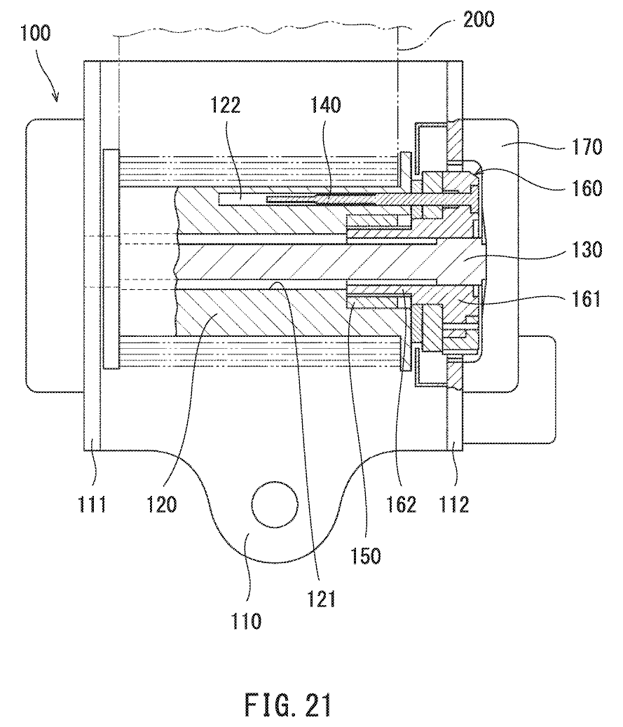

### DETAILED DESCRIPTION

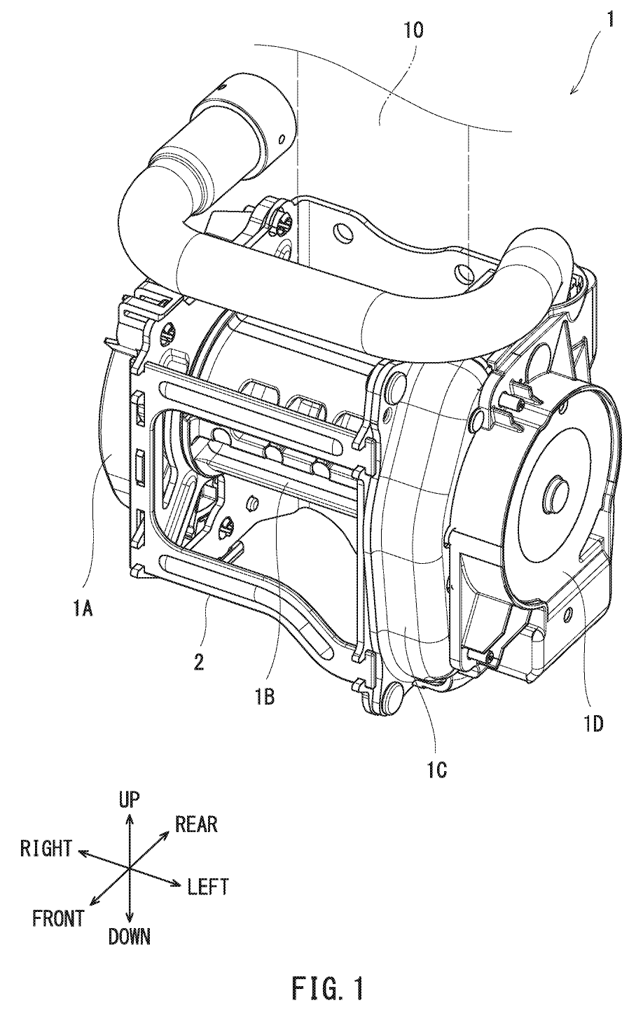

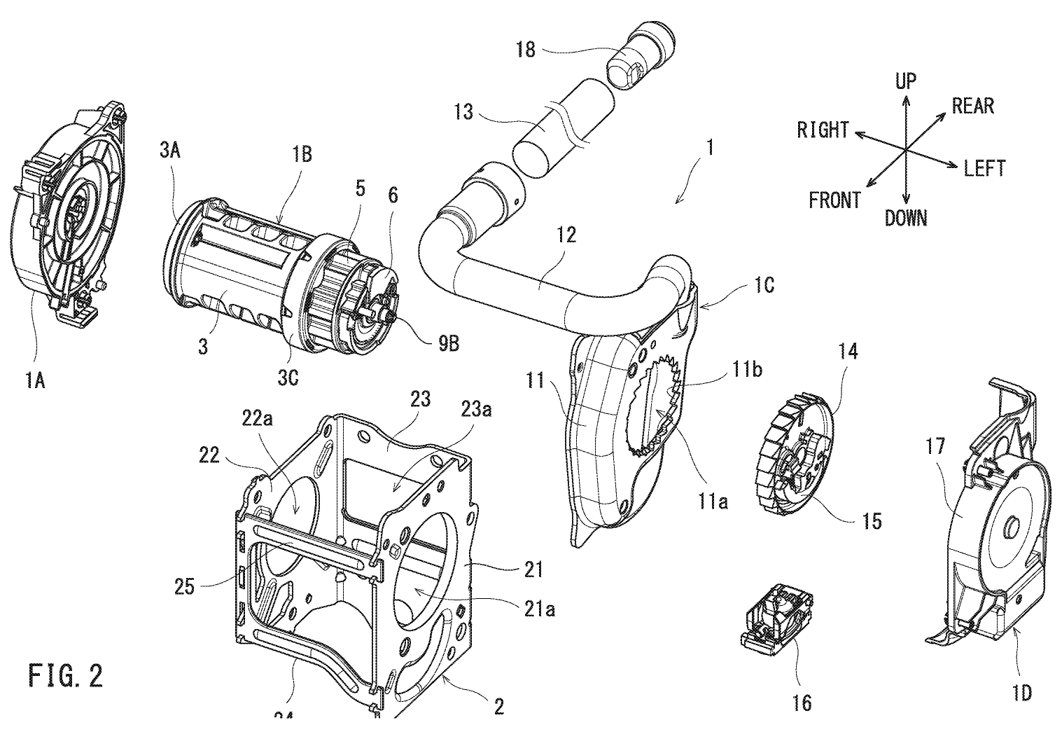

FIGS. 1 and 2 illustrate a seat belt retractor 1 according to one embodiment. The seat belt retractor 1 is a device capable of absorbing impact energy applied to a vehicle occupant in an emergency such as vehicle collision while allowing a webbing 10 serving as a seat belt to be pulled out, and capable of restricting the pull-out amount of the webbing 10.

Specifically, the seat belt retractor 1 includes a housing 2, a winding spring unit 1A, a winding drum unit 1B, a pretensioner 1C, and a lock unit 1D. The winding drum unit 1B includes a winding drum 3 on which the webbing 10 is wound. The housing 2 includes a first side wall 21 and a second side wall 22 that are opposed to each other in an axial direction of the winding drum 3.

The winding drum 3 is located between the first and second side walls 21 and 22 and is rotatable in a winding direction for winding of the webbing 10 and in a pull-out direction for pull-out of the webbing 10. The housing 2 includes a back plate 23 formed by sheet metal processing together with the first and second side walls 21 and 22 and extending perpendicular to the first and second side walls 21 and 22. The back plate 23 need not be formed by sheet metal processing together with the first and second side walls 21 and 22. The first and second side walls 21 and 22 formed separately from the back plate 23 may be mounted to the back plate 23.

Hereinafter, for convenience of description, the opposite directions along the axis of the winding drum 3 will be referred to as the leftward and rightward directions, and the opposite directions along the thickness of the back plate 23 will be referred to as the forward and rearward directions. The direction from the second side wall 22 toward the first side wall 21 is the leftward direction, and the direction from the first side wall 21 toward the second side wall 22 is the rightward direction. The direction from the back plate 23 toward the side walls 21 and 22 is the forward direction, and the opposite direction is the rearward direction. The leftward direction is an example of a first axial direction, and the rightward direction is an example of a second axial direction. As illustrated in FIGS. 1 and 2, one of the opposite directions orthogonal to the leftward and rightward directions and the forward and rearward directions will be referred to as the upward direction, and the other opposite direction will be referred to as the downward direction.

Lower portions of the front sides of the first and second side walls 21 and 22 of the housing 2 are connected to each other by a connecting bar 24, and upper portions of the front sides of the first and second side walls 21 and 22 are connected to each other by a connecting bar 25. The first and second side walls 21 and 22 respectively include through holes 21a and 22a through which the winding drum 3 is inserted into the housing 2. The back plate 23 includes a through hole 23a through which the winding drum 3 is exposed outside the housing 2.

The winding spring unit 1A is mounted on the second side wall 22 of the housing 2, and the pretensioner 1C is mounted on the first side wall 21 of the housing 2. The lock unit 1D is mounted on the pretensioner 1C.

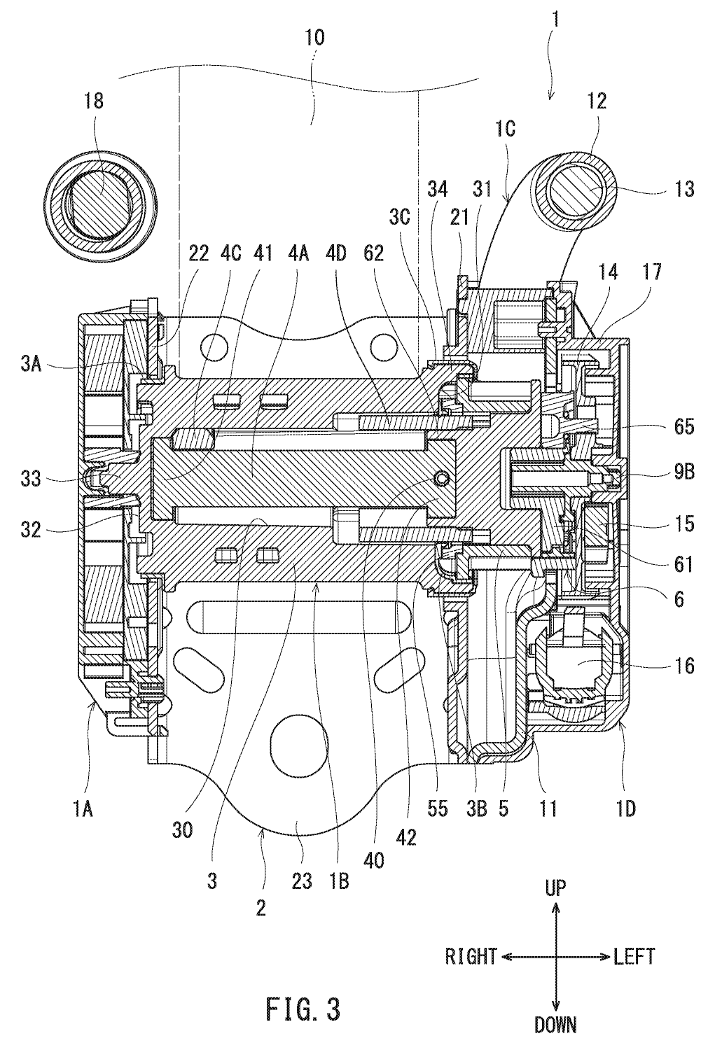

As illustrated in FIG. 3, the winding drum 3 includes a first end surface 31 adjacent to the first side wall 21 of the housing 2 and a second end surface 32 adjacent to the second side wall 22 of the housing 2. In the present embodiment, the winding drum 3 includes a shaft portion 33 projecting rightward from the second end surface 32, and the shaft portion 33 is rotatably supported by the winding spring unit 1A. Alternatively, a torsion bar described later, which serves as an impact energy absorbing member 4A, may extend through the winding drum 3, and the right end of the torsion bar may be rotatably supported by the winding spring unit 1A. The configuration of the winding spring unit 1A is well known and will therefore not be described in detail.

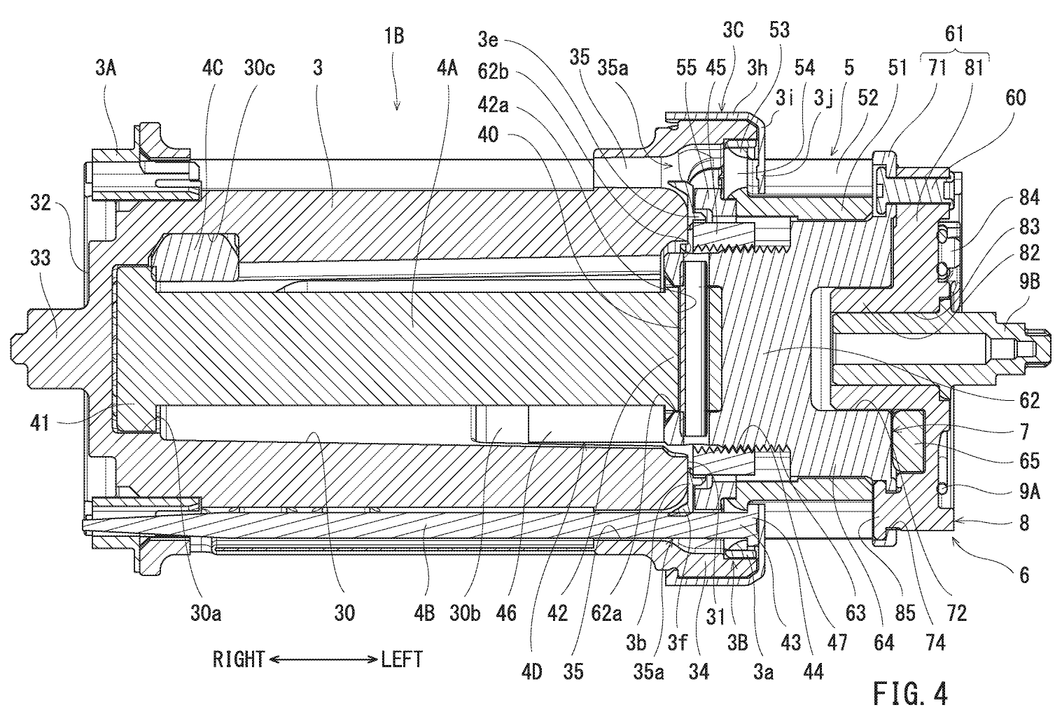

As illustrated in FIGS. 4 to 7, the winding drum unit 1B includes, in addition to the winding drum 3, bushes 3A and 3B, an impact energy absorbing member 4A, a clip 4C, an impact energy absorbing wire 4B, a ring member 55, a holding member 5, a stopper member 4D, a cap member 3C, a locking base 6, a return spring 9A, and a rotation shaft 9B. In the present embodiment, the holding member 5 also functions as a drive wheel of the pretensioner 1C.

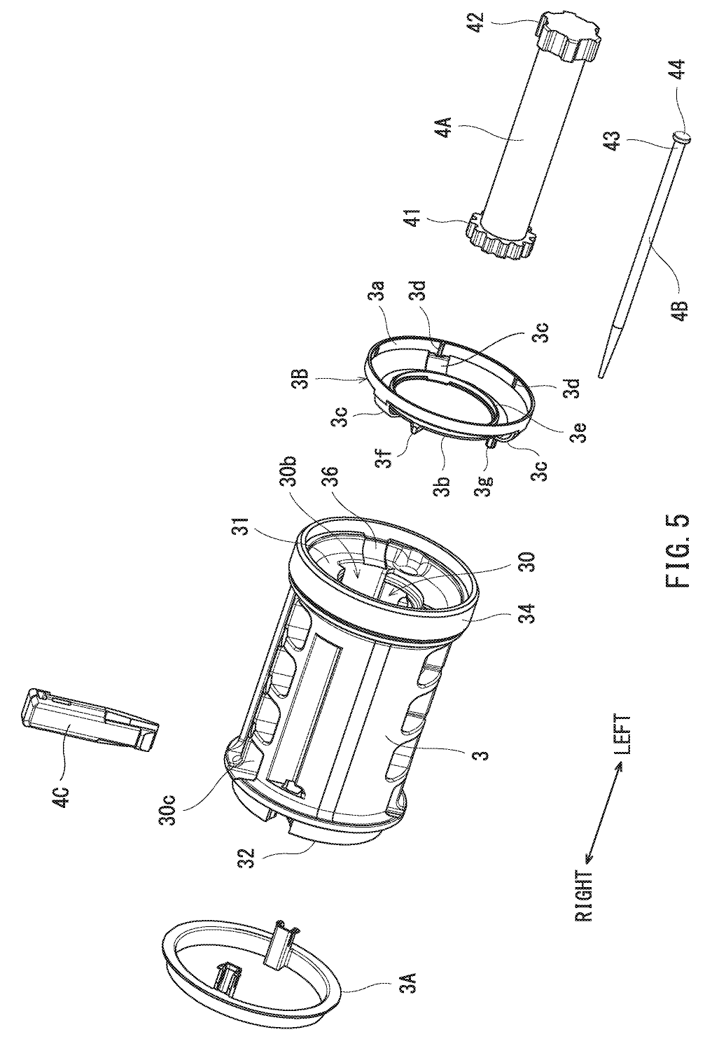

As illustrated in FIGS. 3 and 5, the right end of the winding drum 3 is located in the through hole 22a of the second side wall 22, and the left end of the winding drum 3 is located in the through hole 21a of the first side wall 21. The bush 3A is annular, mounted on the right end of the winding drum 3, and located in the through hole 22a. The left end of the winding drum 3 includes a tubular rib 34 protruding from the edge of the first end surface 31. The outer peripheral surface of the rib 34 faces the inner peripheral surface of the through hole 22a of the second side wall 22. The ring member 55 and the holding member 5 are inserted into the rib 34.

The cap member 3C is annular, mounted on the left end of the winding drum 3, and located in the through hole 21a. The bush 3A and the cap member 3C serve as emergency means for enabling the winding drum 3 to rotate smoothly even when the winding drum 3 is displaced relative to the housing 2 in a vehicle emergency. That is, the cap member 3C also functions as a bearing. The configuration of the cap member 3C will be described in detail later.

As illustrated in FIGS. 4 and 5, the bush 3B is mounted on the left end of the winding drum 3 to cover a portion of the inner peripheral surface of the rib 34, which is closer to the distal end of the rib 34 than the proximal end of the rib 34, and a portion of the first end surface 31, which is closer to the center of the first end surface 31 than the outer edge of the first end surface 31. When the winding drum 3 rotates relative to the locking base 6, the bush 3B slides relative to the holding member 5 and the ring member 55.

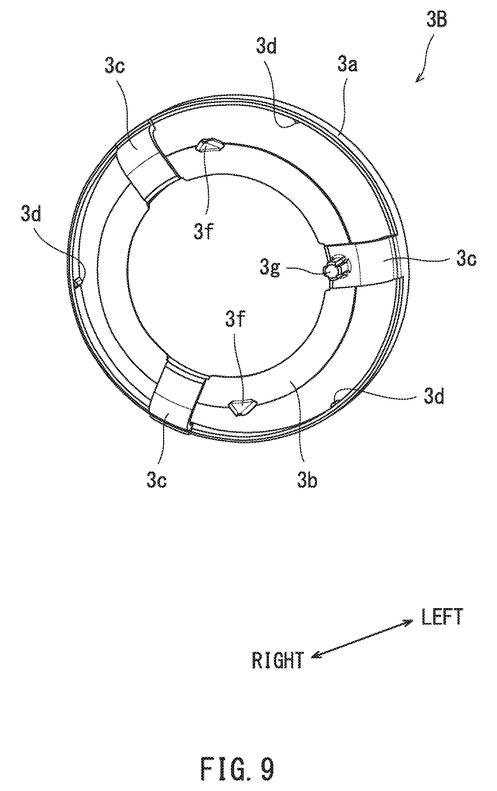

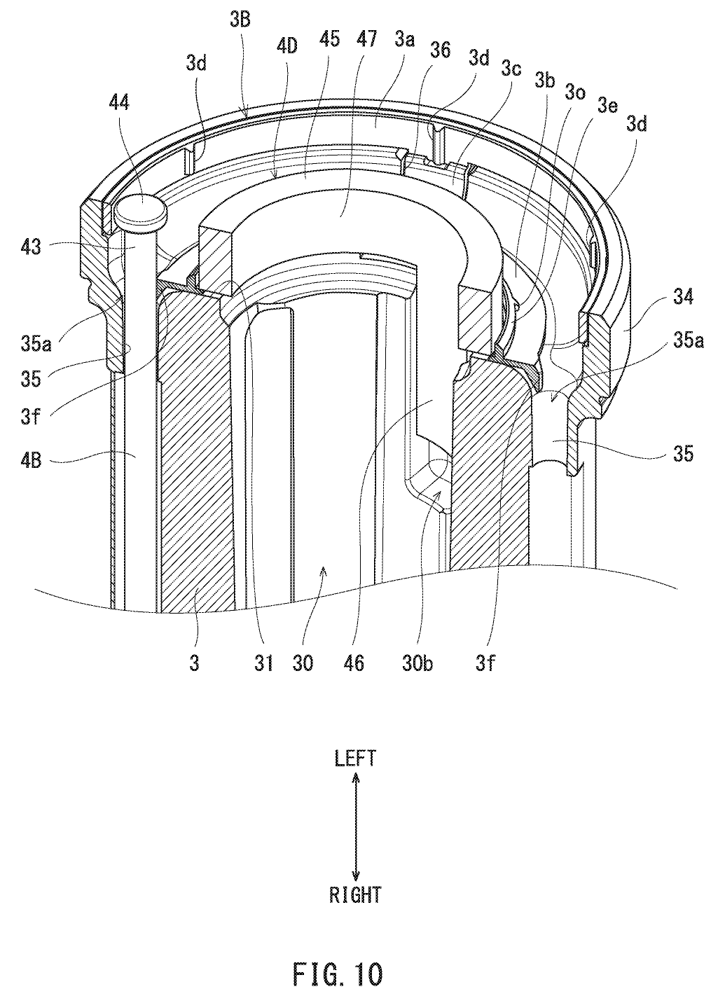

To be more specific, as illustrated in FIGS. 9 and 10, the bush 3B includes: a wall portion 3a that contacts the inner peripheral surface of the rib 34 of the winding drum 3; a ring portion 3b that contacts the first end surface 31 of the winding drum 3; and a plurality of connection portions 3c connecting the wall portion 3a to the ring portion 3b. In the illustrated example, the number of the connection portions 3c is three, although this number is not limiting.

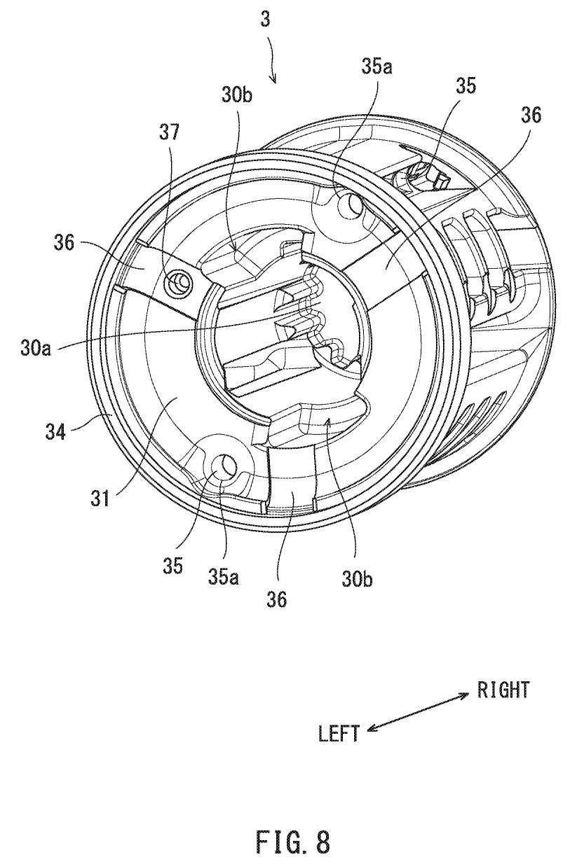

As illustrated in FIG. 8, the left end of the winding drum 3 includes a plurality of holding grooves 36 into which the connection portions 3c of the bush 3B are fitted. Each holding groove 36 extends over a proximal portion of the inner peripheral surface of the rib 34, which is closer to the proximal end of the rib 34 than the distal end of the rib 34, and the first end surface 31. In the illustrated example, the number of the holding grooves 36 is three, although this number is not limiting. Furthermore, one of the holding grooves 36 includes an insertion hole 37 into which a boss 3g located on one of the connection portions 3c is inserted.

When the ring member 55 and the holding member 5 have been mounted on the winding drum 3, the wall portion 3a is located between the outer peripheral surface of a flange portion 53 (described later) of the holding member 5 and the inner peripheral surface of the rib 34, and the ring portion 3b is located between the first end surface 31 of the winding drum 3 and the right end surface of the ring member 55. The inner peripheral surface of the wall portion 3a includes a plurality of protrusions 3d for improving the sliding properties of the holding member 5. The presence of the bush 3B prevents rattling of the holding member 5 on the winding drum 3.

When the stopper member 4D has been mounted on the winding drum 3, the ring portion 3b serves to prevent rattling of the stopper member 4D. Specifically, the inner peripheral surface of the ring portion 3b contacts the outer peripheral surfaces of claw portions 46 (described later) of the stopper member 4D.

As illustrated in FIGS. 5 and 10, there is a tubular rib 3e near the inner edge of the ring portion 3b, and the rib 3e protrudes leftward from the ring portion 3b. The rib 3e is located between the outer peripheral surface of an annular portion 45 (described later) of the stopper member 4D and the inner peripheral surface of the ring member 55. The outer peripheral surface of the rib 3e includes a plurality of protrusions 3o for preventing rattling of the ring member 55 and improving the sliding properties of the ring member 55.

A biasing piece 3f projects from the outer edge of the ring portion 3b. The biasing piece 3f enters an opening 35a of a slot 35 described later to bias the impact energy absorbing wire 4B outward in the radial direction of the winding drum 3. As a result, rattling of the impact energy absorbing wire 4B in the slot 35 can be prevented.

The bushes 3A and 3B and the cap member 3C are made of a material having better sliding properties with respect to metals than sliding between metals. Examples of such materials include fluororesin, polyacetal, and polypropylene.

The winding drum 3 includes a central hole 30 extending along the central axis of the winding drum 3. In the present embodiment, the central hole 30 is a bottomed hole that opens only leftward. Alternatively, when, as mentioned above, the torsion bar serving as the impact energy absorbing member 4A extends through the winding drum 3, the central hole 30 may open both leftward and rightward.

The ring member 55 and the holding member 5 are located to the left of the winding drum 3 and are rotatable relative to the winding drum 3 due to of the bush 3B. The ring member 55 and the holding member 5 form an annular shape extending along the periphery of the central hole 30 of the winding drum 3 and facing the first end surface 31.

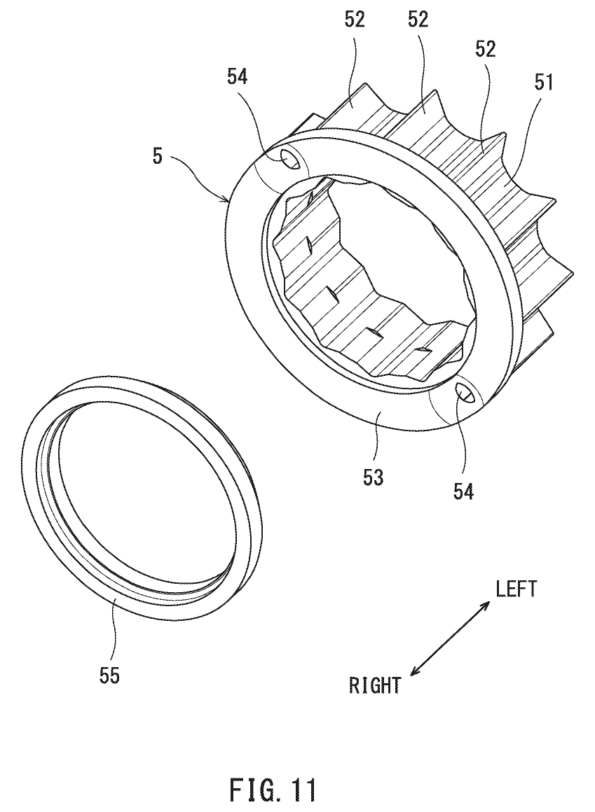

As illustrated in FIG. 11, the holding member 5 includes a tubular main body portion 51, a plurality of engagement teeth 52 formed on the outer peripheral surface of the main body portion 51, and an annular flange portion 53 located to the right of the engagement teeth 52 and projecting radially outward from the main body portion 51. In other words, the flange portion 53 is located closer to the winding drum 3 than the engagement teeth 52. The inner edge of the right surface of the flange portion 53 includes a recess, into which the left end of the ring member 55 is inserted. Thus, the ring member 55 is rotatable relative to the holding member 5.

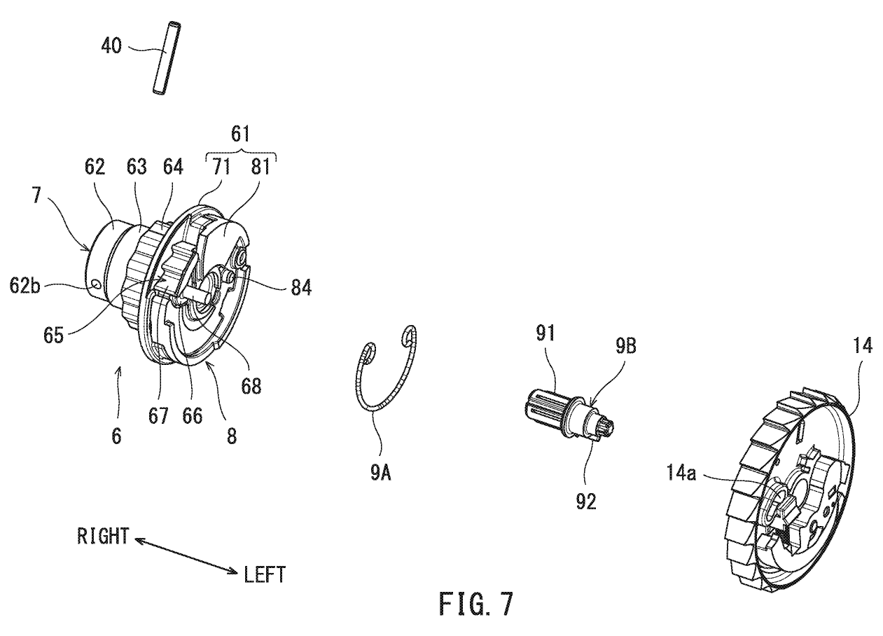

As illustrated in FIGS. 4 and 7, the locking base 6 mentioned above is mounted on, and rotatable together with, the holding member 5. The locking base 6 includes: a main body portion 61 located to the left of the holding member 5 and across the holding member 5 from the winding drum 3 in the axial direction of the winding drum 3; and a shaft portion 62 projecting from the main body portion 61 into an internal space defined by the holding member 5 and the ring member 55, the shaft portion 62 being coaxial with the winding drum 3.

The shaft portion 62 includes a male thread 63 formed on the outer peripheral surface of a portion located toward the distal end of the shaft portion 62, in the other words, a portion located closer to the distal end of the shaft portion 62 than the proximal end of the shaft portion 62. In the present embodiment, the shaft portion 62 includes a small-diameter distal portion, a middle portion having a slightly larger diameter than the distal portion and including the male thread 63, and a proximal portion 64 protruding radially outward beyond the male thread 63 at a portion of the shaft portion 62 from the male thread 63 toward the main body portion 61 of the locking base 6.

The locking base 6 is mountable to the holding member 5 in a plurality of mounting positions that are orientations defined by rotation about the rotational axis of the winding drum 3. To this end, the outer peripheral surface of the proximal portion 64 of the shaft portion 62 includes a plurality of engagement projections arranged at equal angular intervals, and the inner peripheral surface of the main body portion 51 of the holding member 5 includes engagement depressions that mesh with the engagement projections. In the illustrated example, the number of the engagement projections is 12, although this number is not limiting. The outer peripheral surface of the proximal portion 64 and the inner peripheral surface of the main body portion 51 may have a regular polygonal cross-section.

As illustrated in FIGS. 4 and 5, the torsion bar serving as the impact energy absorbing member 4A is inserted into the central hole 30 of the winding drum 3. One end portion of the torsion bar remote from the locking base 6 is coupled to the winding drum 3 and is unable to rotate relative to the winding drum 3, and the other end portion of the torsion bar is coupled to the locking base 6 and is unable to rotate relative to the locking base 6. The one end portion of the torsion bar is an example of a first end, and the other end portion of the torsion bar is an example of a second end.

To be more specific, the one end portion of the torsion bar serving as the impact energy absorbing member 4A includes a splined coupling portion 41, and the other end portion includes a splined coupling portion 42. The bottom of the central hole 30 of the winding drum 3 includes a splined recess 30a for coupling with the coupling portion 41, and the coupling portion 41 is fitted into the recess 30a. The distal end surface of the shaft portion 62 of the locking base 6 includes a splined recess 62a for coupling with the coupling portion 42, and the coupling portion 42 is fitted into the recess 62a.

In the present embodiment, the coupling portion 41 is configured to be fitted into the recess 30a in a plurality of fitting positions that are orientations defined by rotation about the rotational axis of the winding drum 3. The number of the fitting positions is equal to the number of the above-described mounting positions that the locking base 6 can assume when mounted to the holding member 5. With the coupling portion 41 fitted in the recess 30a, the clip 4C is inserted into the central hole 30 through an insertion hole 30c extending from the outer peripheral surface of the winding drum 3 to the central hole 30, and a portion of the clip 4C is positioned in contact with the left side of the coupling portion 41 in the central hole 30. This allows the torsion bar serving as the impact energy absorbing member 4A and the winding drum 3 to remain coupled together.

In the present embodiment, the distal portion of the shaft portion 62 of the locking base 6 includes a through hole 62b, and the coupling portion 42 includes a through hole 42a. The through holes 62b and 42a extend perpendicular to the axial direction of the winding drum 3, and a spring pin 40 is inserted into the through holes 62b and 42a. This allows the torsion bar serving as the impact energy absorbing member 4A and the locking base 6 to remain coupled together.

Under normal states, the torsion bar serving as the impact energy absorbing member 4A connects the winding drum 3 and the locking base 6 such that they are rotatable together. In case that a pull-out force applied to the webbing 10 exceeds a predetermined level while the rotation of the locking base 6 in the pull-out direction is prevented, the torsion bar plastically deforms to absorb impact energy while permitting relative rotation between the winding drum 3 and the locking base 6.

The impact energy absorbing wire 4B absorbs impact energy during an initial phase of relative rotation between the winding drum 3 and the locking base 6. In the present embodiment, as illustrated in FIG. 8, the winding drum 3 includes two slots 35 spaced at an interval of 180 degrees. In the present embodiment, the slots 35 open both leftward and rightward. Alternatively, the slots 35 may open only leftward. In the present embodiment, each slot 35 is shaped as a groove the entirety of which, excluding both ends, is recessed obliquely from the outer peripheral surface of the winding drum 3. Alternatively, the entirety of each slot 35 may be a hole extending in the axial direction of the winding drum 3. There may be only a single slot 35.

As illustrated in FIG. 4, the impact energy absorbing wire 4B is received in one of the slots 35, with its head portion 43 protruding from an opening 35a of the slot 35. The head portion of the impact energy absorbing wire 4B is attached to the flange portion 53 of the holding member 5. During relative rotation between the winding drum 3 and the locking base 6, the impact energy absorbing wire 4B is pulled out from the opening 35a while plastically deforming to absorb impact energy. When pulled out from the opening 35a of the slot 35, the impact energy absorbing wire 4B is wound on the ring member 55.

As illustrated in FIGS. 4 and 11, the head portion 43 of the impact energy absorbing wire 4B extends through the flange portion 53 of the holding member 5 in the axial direction of the winding drum 3. The flange portion 53 of the holding member 5 includes two holding holes 54 spaced at an interval of 180 degrees. The head portion 43 of the impact energy absorbing wire 4B is inserted into one of the holding holes 54. The head portion 43 of the impact energy absorbing wire 4B includes a retainer portion 44 having a larger diameter than the holding holes 54. Alternatively, for example, when the engagement teeth 52 are sufficiently thick, the engagement teeth 52 may include a holding hole 54, and the head portion 43 of the impact energy absorbing wire 4B may extend through the engagement teeth 52 in the axial direction of the winding drum 3.

The stopper member 4D defines the allowable amount of relative rotation between the winding drum 3 and the locking base 6 during impact energy absorption by the impact energy absorbing member 4A. The stopper member 4D is held in the central hole 30 of the winding drum 3, and is unable to rotate relative to the winding drum 3 but is movable in the leftward and rightward directions.

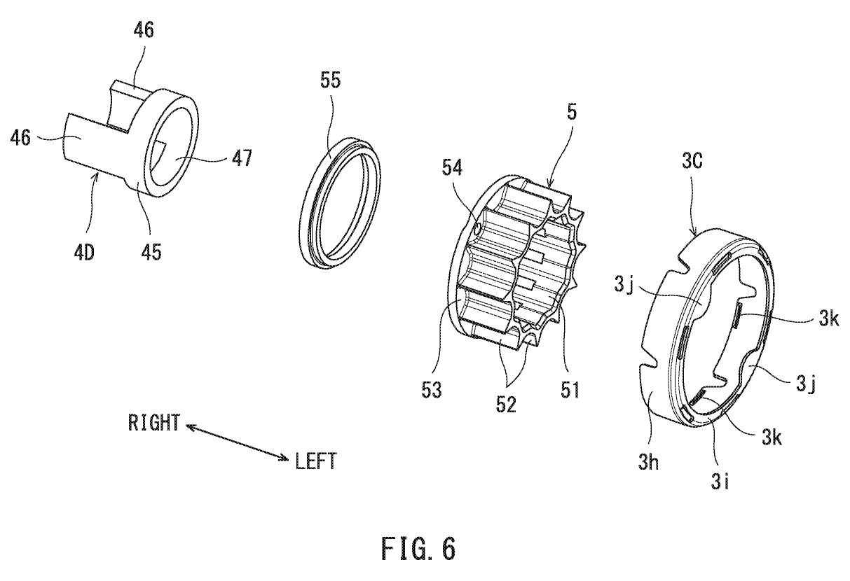

As illustrated in FIGS. 4 and 6, the stopper member 4D has the shape of a tube, into which the torsion bar serving as the impact energy absorbing member 4A is inserted. The inner peripheral surface of the stopper member 4D includes a female thread 47 screwed on to the male thread 63 of the shaft portion 62 of the locking base 6.

In the present embodiment, the stopper member 4D includes an annular portion 45 and two claw portions 46 projecting rightward from the annular portion 45, the two claw portions 46 being spaced at an interval of 180 degrees. The central hole 30 of the winding drum 3 includes two guide grooves 30b spaced at an interval of 180 degrees. The two claw portions 46 are fitted, respectively, into the two guide grooves 30b, so that the stopper member 4D is held in the central hole 30 of the winding drum 3, and is unable to rotate relative to the winding drum 3 but is movable in the leftward and rightward directions. The stopper member 4D need not include the claw portions 46; alternatively, the profile of the stopper member 4D and the left end of the central hole 30 of the winding drum 3 may be polygonal in cross-section.

In the present embodiment, as illustrated in FIGS. 3 and 4, during relative rotation between the winding drum 3 and the locking base 6, the stopper member 4D moves from an initial position, where the stopper member 4D is spaced apart from the proximal portion 64 of the shaft portion 62, to a position where the stopper member 4D contacts the proximal portion 64. As a result, the relative rotation between the winding drum 3 and the locking base 6 is limited to a predetermined amount.

In the present embodiment, each of the dimensions of the inner contours of the holding member 5 and the ring member 55, as viewed in the axial direction of the winding drum 3, is greater than the dimension of the outer contour of the stopper member 4D. Accordingly, after the ring member 55 and the holding member 5 have been mounted on the winding drum 3, the stopper member 4D can be inserted into the central hole 30 in a direction from the holding member 5 toward the winding drum 3.

In a vehicle emergency, the pretensioner 1C rotates the holding member 5, thereby rotating the winding drum 3 in the winding direction via the locking base 6 and the impact energy absorbing member 4A. As illustrated in FIGS. 2 and 3, the pretensioner 1C includes a pretensioner casing 11 mounted on the first side wall 21 of the housing 2, a bent pipe 12 extending from the pretensioner casing 11, a movable member 13 located within the pipe 12, and a gas generator 18 located within the distal end of the pipe 12.

The movable member 13 moves during operation of the pretensioner 1C. For example, the movable member 13 is an elongate rod-shaped member made of resin, and plastically deforms as the engagement teeth 52 of the holding member 5 bite into it. Alternatively, the movable member 13 may be constituted by separate segments arranged at intervals equal to the pitch of the engagement teeth 52 of the holding member 5. The separate segments are, for example, but not limited to, spherical objects. In a vehicle emergency, the movable member 13 is pushed out of the pipe 12 by the gas generated by the gas generator 18 and engages with the engagement teeth 52 of the holding member 5, thereby rotating the holding member 5 in the winding direction. In conjunction with the rotation of the holding member 5, the locking base 6, the impact energy absorbing member 4A, and the winding drum 3 also rotate. After the pretensioner 1C is actuated, the pressure of the gas in the pipe 12 blocks the movable member 13 from being pushed back into the pipe 12. Consequently, the rotation of the holding member 5 in the pull-out direction is prevented.

As illustrated in FIGS. 2 and 3, the pretensioner casing 11 includes an opening 11a into which the locking base 6 is inserted, and inner teeth 11b are formed on the edge of the opening 11a. The locking base 6 includes a lock member 65 engageable with the inner teeth 11b. In a vehicle emergency, the lock member 65 engages with the inner teeth 11b to prevent the rotation of the locking base 6 in the pull-out direction.

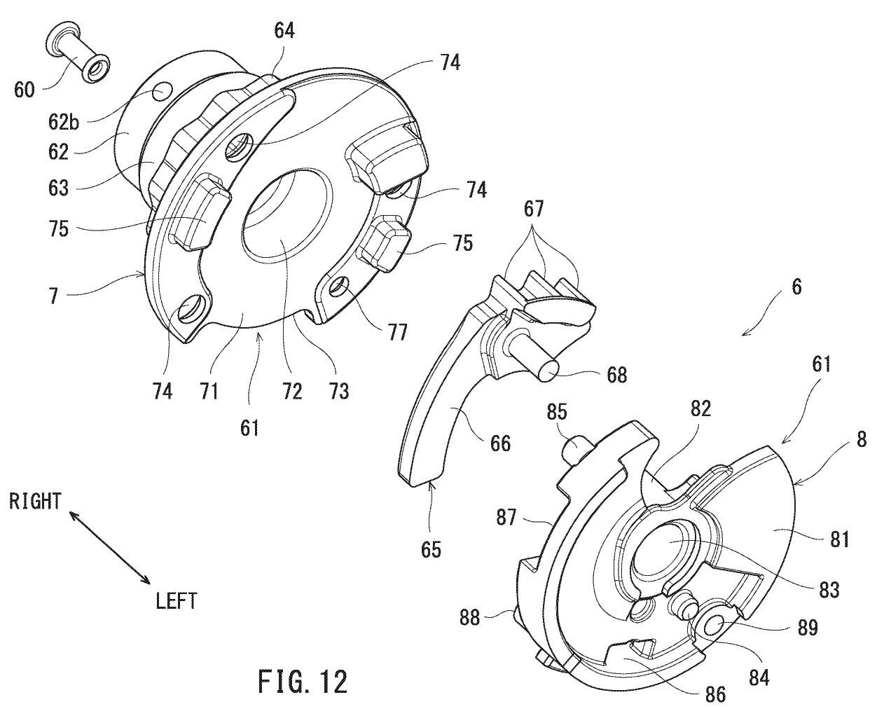

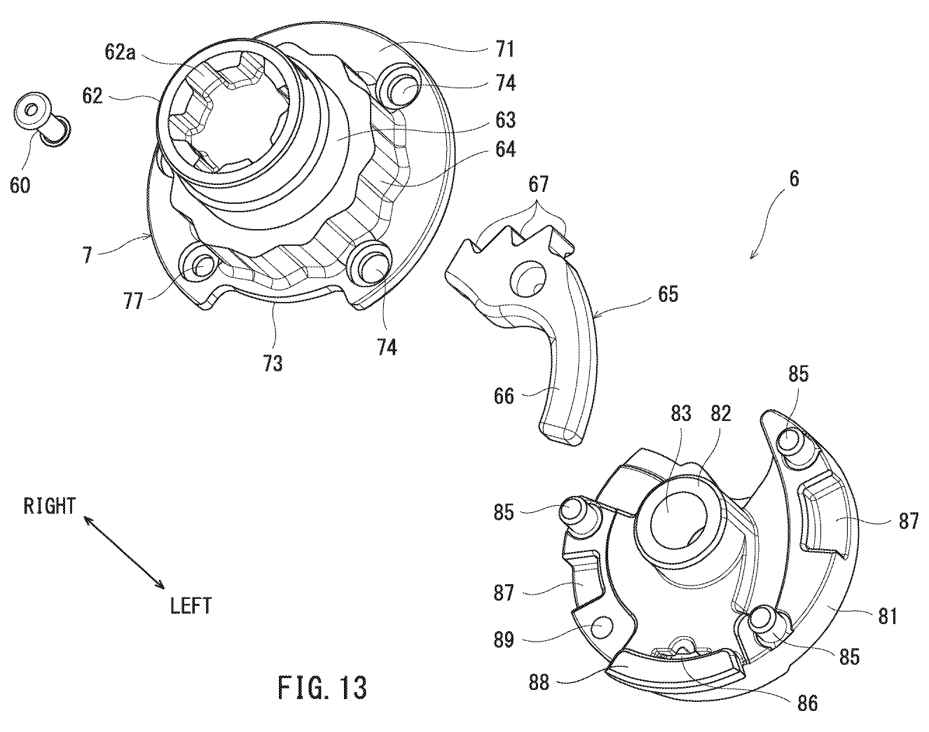

As illustrated in FIGS. 12 and 13, the locking base 6 includes a first base member 7 including the right side of the main body portion 61 and the shaft portion 62, and a second base member 8 including the left side of the main body portion 61. The lock member 65 is held between the first and second base members 7 and 8.

To be more specific, the first base member 7 includes a first main body portion 71, and the second base member 8 includes a second main body portion 81. The first and second main body portions 71 and 81 are generally shaped as discs that are fitted on each other. These portions 71 and 81 constitute the main body portion 61 of the locking base 6.

The first main body portion 71 includes a recess 72 at the center of its left surface, and a fitting protrusion 82 that fits into the recess 72 is located at the center of the right surface of the second main body portion 81. The first main body portion 71 includes a cut 73 at its edge, and an engagement projection 88 that engages with the cut 73 is located at the edge of the second main body portion 81. Furthermore, the second main body portion 81 includes two engagement depressions 87 at the edge of its right surface, and two engagement projections 75 that engage with the engagement depressions 87 are located at the edge of the left surface of the first main body portion 71.

In the present embodiment, the second main body portion 81 includes three crimping protrusions 85 on its right surface, and the first main body portion 71 includes three through holes 74 into which the crimping protrusions 85 are inserted. The portions of the crimping protrusions 85 that protrude from the through holes 74 are crimped to connect the first and second base members 7 and 8 together. FIGS. 12 and 13 show the crimping protrusions 85 that have not yet been crimped. The number of the crimping protrusions 85 and the number of the through holes 74 need not be three, and may be one, two, or four or more.

Furthermore, in the present embodiment, a rivet 60 is also used for connection between the first and second base members 7 and 8. To this end, the first and second main body portions 71 and 81 include, respectively, through holes 77 and 89 for the rivet 60.

The second base member 8 includes a through hole 83 located at the center of, and extending through, the second base member 8. The second base member 8 further includes a pin 84 projecting leftward from the left surface of the second main body portion 81.

The lock member 65 includes: a main body portion 66 having the form of a generally arc-shaped plate and held by the first main body portion 71 of the first base member 7 and the second main body portion 81 of the second base member 8; a plurality of engagement teeth 67 formed on the outer side surface of the main body portion 66 and engageable with the inner teeth 11b described above; and an operation shaft 68 projecting leftward from the main body portion 66. In the illustrated example, the number of the engagement teeth 67 is three, although this number is not limiting.

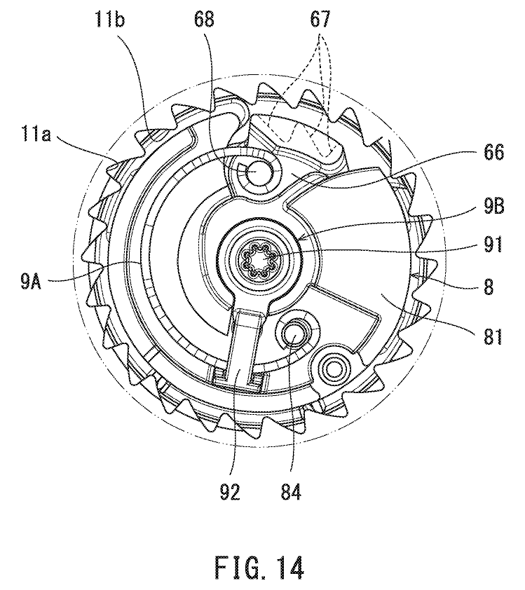

The return spring 9A mentioned above is generally arc-shaped as shown in FIG. 7. One end of the return spring 9A engages with the operation shaft 68 of the lock member 65, and the other end engages with the pin 84 of the locking base 6. The return spring 9A serves to retain the lock member 65 in a non-engagement position shown in FIG. 14.

The lock member 65 is operated by a synchronized gear 14 shown in FIGS. 2 and 7. As illustrated in FIG. 2, the lock unit 1D includes a cover member 17 enclosing the synchronized gear 14 and a vehicle sensor 16. The synchronized gear 14 is equipped with a webbing sensor 15. The webbing sensor 15 is activated in response to rapid pull-out of the webbing 10, thereby preventing the rotation of the synchronized gear 14 in the pull-out direction. The vehicle sensor 16 is activated in response to a significant change in vehicle acceleration, thereby preventing the rotation of the synchronized gear 14 in the pull-out direction.

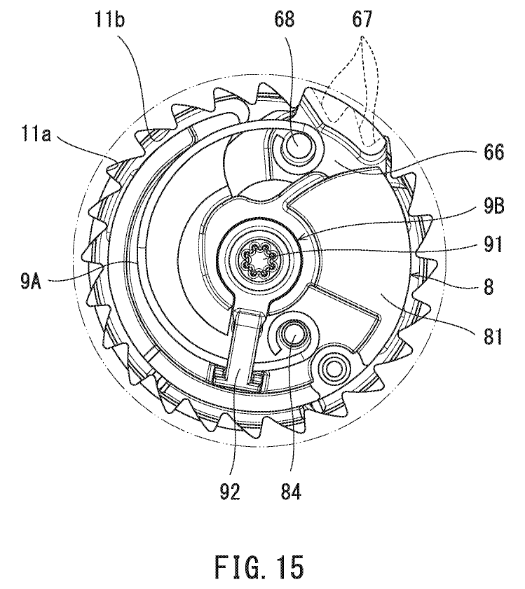

Once the rotation of the synchronized gear 14 in the pull-out direction is prevented, the locking base 6 rotates together with the winding drum 3 relative to the synchronized gear 14, and the operation shaft 68 of the lock member 65 is operated by a guide hole 14a of the synchronized gear 14 which is shown in FIG. 7. As a result, the lock member 65 moves from the non-engagement position shown in FIG. 14 to an engagement position shown in FIG. 15.

As illustrated in FIGS. 7 and 12, the rotation shaft 9B mentioned above includes a rod-shaped main body portion 91 and an arm 92 extending radially outward from the main body portion 91. The right portion of the main body portion 91 is fitted into the through hole 83 of the second base member 8. The arm 92 serves to hold the return spring 9A in position. A hook at the distal end of the arm 92 engages with an engagement hole 86 of the second main body portion 81 of the second base member 8 of the locking base 6.

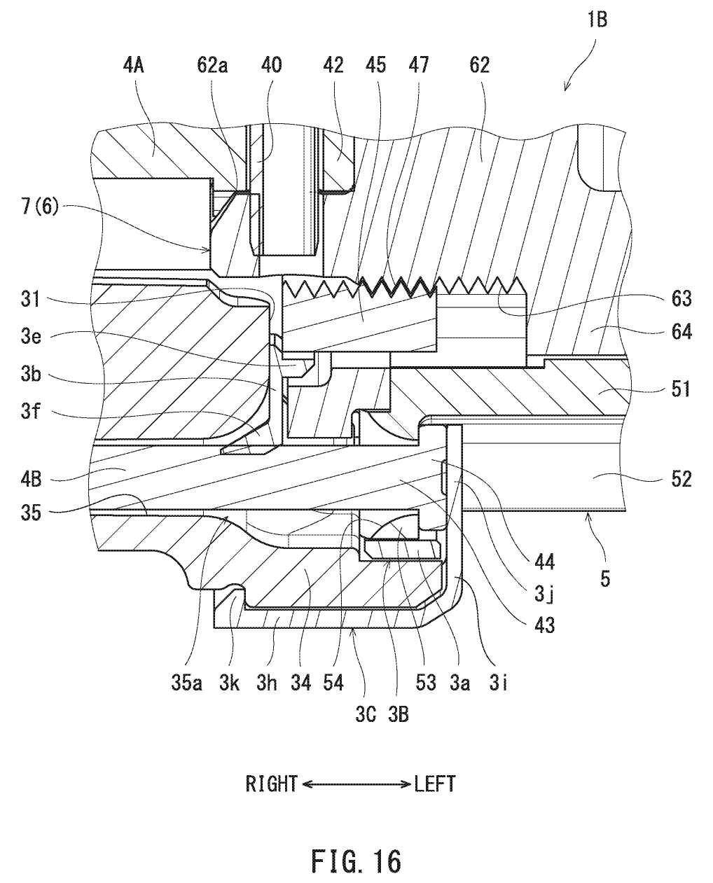

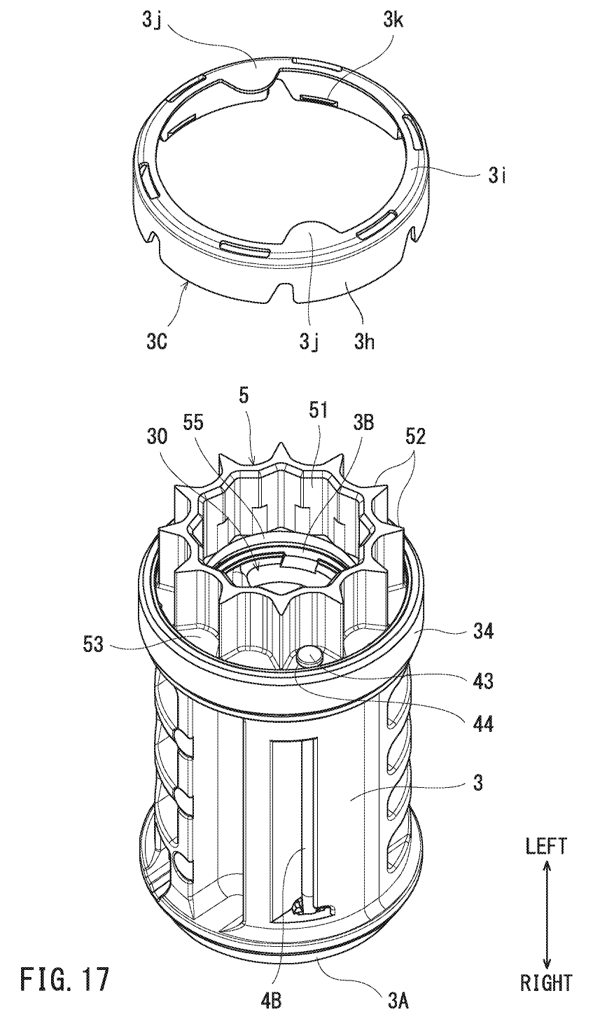

Hereinafter, the configuration of the cap member 3C will be described in detail with reference to FIGS. 16 and 17. As illustrated in FIGS. 4 and 6, the cap member 3C includes an outer wall portion 3h covering the outer peripheral surface of the left end of the winding drum 3, and a ring portion 3i projecting inward from the left end of the outer wall portion 3h in the radial direction of the winding drum 3 and covering the end surface of the rib 34. As illustrated in FIG. 3, the outer wall portion 3h is located in the through hole 21a of the first side wall 21 of the housing 2.

The cap member 3C further includes two cover portions 3j projecting inward from the ring portion 3i in the radial direction of the winding drum 3. In other words, the cover portions 3j are connected to the left end of the outer wall portion 3h via the ring portion 3i.

Regardless of which slot 35 the impact energy absorbing wire 4B is received in, either of the two cover portions 3j contacts the head portion 43 of the impact energy absorbing wire 4B, thereby serving to prevent the impact energy absorbing wire 4B from being displaced from the slot 35. In the present embodiment, either of the cover portions 3j contacts the retainer portion 44 of the head portion 43.

In the present embodiment, either of the cover portions 3j comes into surface contact with the retainer portion 44 of the impact energy absorbing wire 4B in the axial direction of the winding drum 3. Alternatively, either of the cover portions 3j may contact the head portion 43 of the impact energy absorbing wire 4B in a direction inclined with respect to the axial direction of the winding drum 3. In the present embodiment, either of the cover portions 3j is always in contact with the head portion 43 of the impact energy absorbing wire 4B. Alternatively, there may be a small gap between the cover portion 3j and the head portion 43 of the impact energy absorbing wire 4B.

The cap member 3C further includes claws 3k projecting inward from the right end of the outer wall portion 3h in the radial direction of the winding drum 3. The right end of the outer wall portion 3h is the end opposite the cover portions 3j. The left end of the winding drum 3 includes stepped portions located rightward of the rib 34, and the claws 3k engage with the stepped portions.

As described above, in the seat belt retractor 1 of the present embodiment, the cap member 3C mounted on the winding drum 3 includes the cover portions 3j, and either of the cover portions 3j contacts the head portion 43 of the impact energy absorbing wire 4B to prevent the impact energy absorbing wire 4B from being displaced from the slot 35 of the winding drum 3. Accordingly, the impact energy absorbing wire 4B can be reliably retained in the slot 35 of the winding drum 3. Furthermore, in the present embodiment, where either of the cover portions 3j is always in contact with the head portion 43 of the impact energy absorbing wire 4B, noise caused by vibration of the head portion 43 of the impact energy absorbing wire 4B can be suppressed. In addition, a sufficient length of the impact energy absorbing wire 4B can be retained in the slot 35 of the winding drum 3. Accordingly, during relative rotation between the winding drum 3 and the locking base 6, the impact energy absorbing wire 4B is pulled out from the opening 35a to a sufficient amount while plastically deforming, thereby reliably absorbing impact energy.

The cap member 3C includes the outer wall portion 3h located in the through hole 21a of the first side wall 21 of the housing 2. Accordingly, the left end of the winding drum 3 does not directly contact the inner peripheral surface of the through hole 21a even when the winding drum 3 is displaced relative to the housing 2 in a vehicle emergency. Furthermore, the cap member 3C is made of a material having better sliding properties with respect to metals than sliding between metals. This reduces the sliding resistance between the winding drum 3 and the housing 2 when the winding drum 3 is displaced relative to the housing 2.

Furthermore, since the cap member 3C includes the claws 3k that engage with the left end of the winding drum 3, the cap member 3C can be easily mounted to the winding drum 3 and can be retained on the winding drum 3 by engagement of the claws 3k.

In addition, in the present embodiment, since the holding member 5 serves as a drive wheel of the pretensioner 1C, the number of additional components required to construct the pretensioner 1C can be reduced. Furthermore, either of the cover portions 3j of the cap member 3C prevents the head portion 43 of the impact energy absorbing wire 4B from protruding to the region of engagement between the engagement teeth 52 and the movable member. Thus, the head portion 43 does not adversely affect the operation of the pretensioner 1C.

### Modifications

The present invention is not limited to the embodiment described above, and various modifications can be made without departing from the gist of the present invention.

For example, the impact energy absorbing member 4A is not limited to a torsion bar, and may be any component that absorbs impact energy in response to relative rotation between the winding drum 3 and the locking base 6. For example, the impact energy absorbing member 4A may be a wire that absorbs impact energy by being bent and deformed in response to relative rotation between the winding drum 3 and the locking base 6.

The pretensioner 1C may be omitted. In this case, the holding member 5 need not include the engagement teeth 52. The ring member 55 may be integrated with the holding member 5 and unable to rotate relative to the holding member 5.

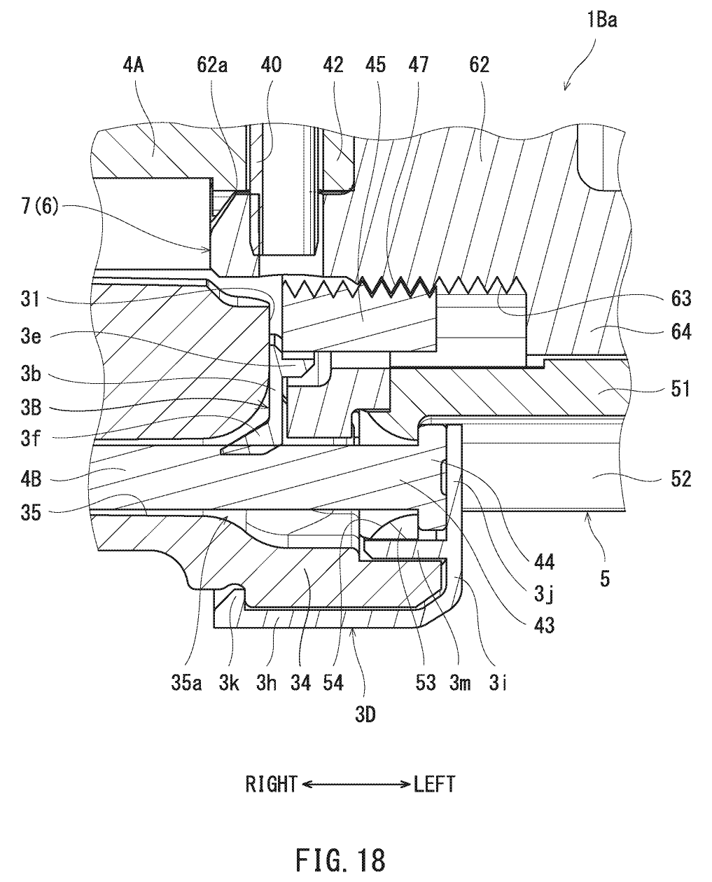

FIG. 18 shows a winding drum unit 1Ba according to a first modification. As in this modification, the wall portion 3a and the connection portions 3c may be omitted from the bush 3B, and a cap member 3D may be used which includes an inner wall portion 3m in addition to the outer wall portion 3h, the ring portion 3i, the cover portions 3j, and the claws 3k. The inner wall portion 3m is located between the outer peripheral surface of the flange portion 53 of the holding member 5 and the inner peripheral surface of the rib 34, and the ring portion 3i and the cover portions 3j are connected to the left end of the inner wall portion 3m.

In this configuration, the holding member 5, on which the locking base 6 is mounted, does not directly contact the rib 34 of the winding drum 3 during relative rotation between the winding drum 3 and the locking base 6. In addition, the cap member 3D may be made of a material having better sliding properties with respect to metals than sliding between metals; in this case, the sliding resistance between the winding drum 3 and the holding member 5 can be reduced during relative rotation between the winding drum 3 and the locking base 6.

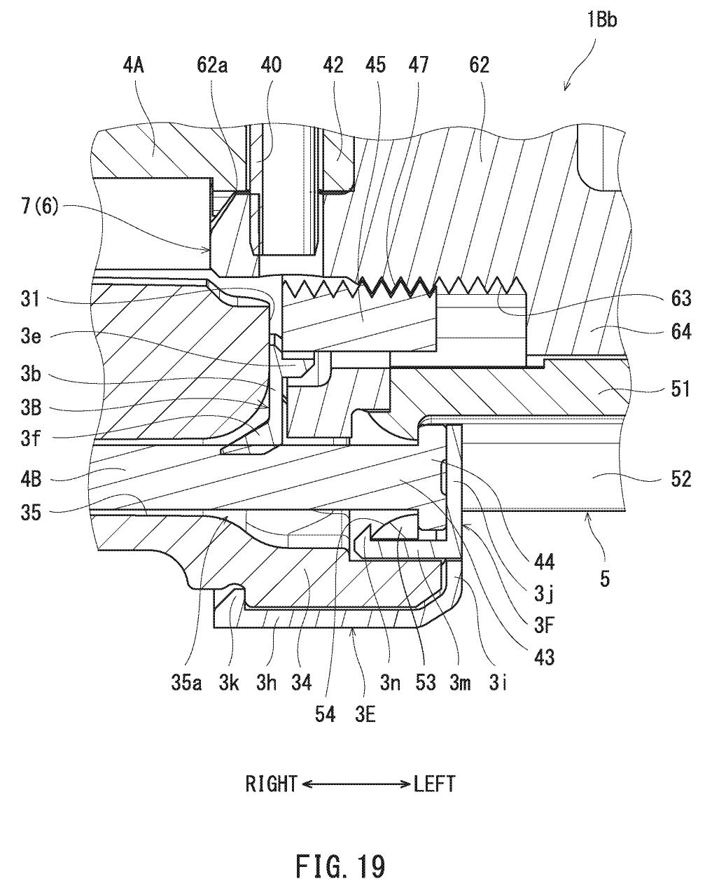

FIG. 19 shows a winding drum unit 1Bb according to a second modification. As in this modification, the wall portion 3a and the connection portions 3c may be omitted from the bush 3B, and a bearing 3E and a cap member 3F may be used. The bearing 3E includes the outer wall portion 3h, the ring portion 3i, and the claws 3k and is mounted on the left end of the winding drum 3, and the cap member 3F includes the inner wall portion 3m, the cover portions 3j, and claws 3n and is mounted on the holding member 5.

The claws 3n of the cap member 3F project inward from the right end of the inner wall portion 3m in the radial direction of the winding drum 3 and engage with the outer edge of the right surface of the flange portion 53 of the holding member 5. The right end of the inner wall portion 3m is the end opposite the cover portions 3j.

In this configuration, the cap member 3F can be easily mounted to the holding member 5 and can be retained on the holding member 5 by engagement of the claws 3n. The cap member 3D shown in FIG. 18 may include claws 3n at the right end of the inner wall portion 3m in addition to the claws 3k at the right end of the outer wall portion 3h, and may be mounted on both the holding member 5 and the winding drum 3.

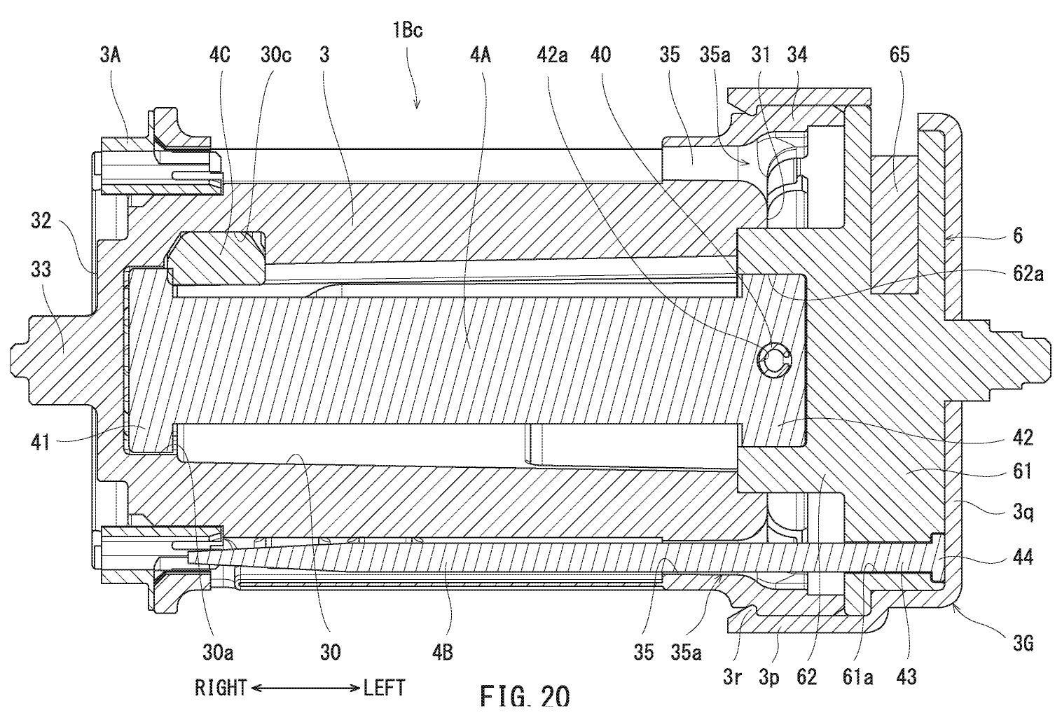

FIG. 20 shows a winding drum unit 1Bc according to a third modification. As in this modification, the ring member 55 and the holding member 5 may be omitted, the locking base 6 may be located to the left of the winding drum 3, and the head portion 43 of the impact energy absorbing wire 4B may be attached to the locking base 6. In addition, a cap member 3G including an outer wall portion 3p, a cover portion 3q, and claws 3r may be mounted on the left end of the winding drum 3. The cap member 3G may be mounted on the locking base 6 rather than on the winding drum 3.

In the third modification, the head portion 43 of the impact energy absorbing wire 4B extends through the main body portion 61 of the locking base 6 in the axial direction of the winding drum 3. The main body portion 61 of the locking base 6 includes a holding hole 61a into which the head portion 43 of the impact energy absorbing wire 4B is inserted. The left surface of the main body portion 61 of the locking base 6 includes a recess for receiving the retainer portion 44 of the head portion 43 of the impact energy absorbing wire 4B.

The outer wall portion 3p of the cap member 3G covers the outer peripheral surface of the left end of the winding drum 3 and the outer peripheral surface of the main body portion 61 of the locking base 6. As in the embodiment described above, the outer wall portion 3p is located in the through hole 21a of the first side wall 21 of the housing 2.

The cover portion 3q of the cap member 3G is disc-shaped, and covers the head portion 43 of the impact energy absorbing wire 4B and the left surface of the locking base 6. The cover portion 3q is connected to the left end of the outer wall portion 3p. In other words, like the cover portions 3j of the above embodiment, the cover portion 3q contacts the head portion 43 of the impact energy absorbing wire 4B, thereby serving to prevent the impact energy absorbing wire 4B from being displaced from the slot 35. In the present modification, the cover portion 3q contacts the retainer portion 44, although this contact is not limiting.

Like the claws 3k of the above embodiment, the claws 3r of the cap member 3G project inward from the right end of the outer wall portion 3p in the radial direction of the winding drum 3, and engage with the left end of the winding drum 3. The right end of the outer wall portion 3p is the end opposite the cover portion 3q.

In this configuration, as in the embodiment described above, the impact energy absorbing wire 4B can be reliably retained in the slot 35 of the winding drum 3. Furthermore, the cover portion 3q may be always in contact with the head portion 43 of the impact energy absorbing wire 4B; in this case, noise caused by vibration of the head portion 43 of the impact energy absorbing wire 4B can be suppressed. In addition, a sufficient length of the impact energy absorbing wire 4B can be retained in the slot 35 of the winding drum 3. Accordingly, during relative rotation between the winding drum 3 and the locking base 6, the impact energy absorbing wire 4B is pulled out from the opening 35a to a sufficient amount while plastically deforming, thereby reliably absorbing impact energy.

The cap member 3G includes the outer wall portion 3p located in the through hole 21a of the first side wall 21 of the housing 2. Accordingly, the left end of the winding drum 3 does not directly contact the inner peripheral surface of the through hole 21a of the first side wall 21 of the housing 2 even when the winding drum 3 is displaced relative to the housing 2 in a vehicle emergency. Furthermore, the cap member 3G may be made of a material having better sliding properties with respect to metals than sliding between metals; in this case, the sliding resistance between the winding drum 3 and the housing 2 can be reduced when the winding drum 3 is displaced relative to the housing 2.

Furthermore, since the cap member 3G includes the claws 3r that engage with the left end of the winding drum 3, the cap member 3G can be easily mounted to the winding drum 3 and can be retained on the winding drum 3 by engagement of the claws 3r.

### Conclusion

A first aspect of the present disclosure provides a seat belt retractor as a first mode of the disclosure, the seat belt retractor including: a housing including a pair of opposed side walls; a winding drum on which a webbing is wound, the winding drum being located between the pair of side walls and rotatable in a winding direction for winding of the webbing and in a pull-out direction for pull-out of the webbing; a holding member located in a first axial direction relative to the winding drum and rotatable relative to the winding drum, the first axial direction being one of opposite axial directions of the winding drum; a locking base mounted on the holding member, rotatable together with the holding member, and configured to be prevented from rotating in the pull-out direction in a vehicle emergency; an impact energy absorbing member including a first end and a second end, coupled to the winding drum at or near the first end and to the locking base at or near the second end, and configured to, under a normal state, connect the winding drum and the locking base such that the winding drum and the locking base are rotatable together, the impact energy absorbing member being further configured to, in case that a pull-out force applied to the webbing exceeds a predetermined level while rotation of the locking base in the pull-out direction is prevented, plastically deform to absorb impact energy while permitting relative rotation between the winding drum and the locking base; an impact energy absorbing wire received in a slot located in the winding drum, the slot having an opening facing in the first axial direction, the impact energy absorbing wire including a head portion protruding from the opening of the slot and attached to the holding member, the impact energy absorbing wire being configured to, during relative rotation between the winding drum and the locking base, be pulled out from the opening of the slot while plastically deforming to absorb impact energy; and a cap member mounted on the holding member or the winding drum, wherein the head portion of the impact energy absorbing wire extends through the holding member in a second axial direction opposite to the first axial direction, and the cap member includes a cover portion configured to contact the head portion of the impact energy absorbing wire to prevent the impact energy absorbing wire from being displaced from the slot.

In the above configuration, the cap member mounted on the holding member or the winding drum includes the cover portion that contacts the head portion of the impact energy absorbing wire to prevent the impact energy absorbing wire from being displaced from the slot of the winding drum. Accordingly, the impact energy absorbing wire can be reliably retained in the slot of the winding drum. Furthermore, the cover portion may be always in contact with the head portion of the impact energy absorbing wire; in this case, noise caused by vibration of the head portion of the impact energy absorbing wire can be suppressed. In addition, a sufficient length of the impact energy absorbing wire can be retained in the slot of the winding drum. Accordingly, during relative rotation between the winding drum and the locking base, the impact energy absorbing wire is pulled out from the opening of the slot to a sufficient amount while plastically deforming, thereby reliably absorbing impact energy. A location “at or near the first end” may correspond to a location closer to the first end than the second end. A location “at or near the second end” may correspond to a location closer to the second end than the first end.

In a seat belt retractor according to a second mode based on the first mode, the cap member may include an outer wall portion covering an outer peripheral surface of a drum end of the winding drum that is located in the first axial direction, the cover portion may be connected to a first outer wall end of the outer wall portion that is located in the first axial direction, the drum end of the winding drum may be located in a through hole extending through one of the side walls that is located in the first axial direction among the side walls, and the outer wall portion of the cap member may be located in the through hole. In this configuration, the end of the winding drum does not directly contact the inner peripheral surface of the through hole even when the winding drum is displaced relative to the housing in a vehicle emergency. Furthermore, the cap member may be made of a material having better sliding properties with respect to metals than sliding between metals; in this case, the sliding resistance between the winding drum and the housing can be reduced when the winding drum is displaced relative to the housing.

In a seat belt retractor according to a third mode based on the second mode, the cap member may include a first claw projecting inward in a radial direction of the winding drum from a second outer wall end of the outer wall portion that is located in the second axial direction, the first claw being engaged with the drum end of the winding drum. In this configuration, the cap member can be easily mounted to the winding drum and can be retained on the winding drum by engagement of the first claw.

In a seat belt retractor according to a fourth mode based on any one of the first to third modes, the drum end of the winding drum that is located in the first axial direction may include a tubular rib into which the holding member is inserted, the cap member may include an inner wall portion located between the holding member and the rib, and the cover portion may be connected to a first inner wall end of the inner wall portion that is located in the first axial direction. In this configuration, the holding member, on which the locking base is mounted, does not directly contact the rib of the winding drum during relative rotation between the winding drum and the locking base. In addition, the cap member may be made of a material having better sliding properties with respect to metals than sliding between metals; in this case, the sliding resistance between the winding drum and the holding member can be reduced during relative rotation between the winding drum and the locking base.

In a seat belt retractor according to a fifth mode based on the fourth mode, the cap member may include a second claw projecting inward in a radial direction of the winding drum from a second inner wall end of the inner wall portion that is located in the second axial direction, the second claw being engaged with the holding member. In this configuration, the cap member can be easily mounted to the holding member and can be retained on the holding member by engagement of the second claw.

A seat belt retractor according to a sixth mode based on any one of the first to fifth modes may further include a pretensioner configured to, in a vehicle emergency, rotate the holding member to rotate the winding drum in the winding direction via the locking base and the impact energy absorbing member. In this configuration, the holding member serves as a drive wheel of the pretensioner. Accordingly, the number of additional components required to construct the pretensioner can be reduced.

In a seat belt retractor according to a seventh mode based on the sixth mode, the holding member may include engagement teeth on an outer periphery of the holding member, the pretensioner may include a movable member that moves during operation of the pretensioner, the movable member being configured to, while moving, engage with the engagement teeth to rotate the holding member, the holding member may include a flange portion located in a portion of the holding member extending from the engagement teeth toward the winding drum, and the head portion of the impact energy absorbing wire may be attached to the flange portion. In this configuration, the cover portion of the cap member prevents the head portion of the impact energy absorbing wire from protruding to the region of engagement between the engagement teeth and the movable member. Thus, the head portion does not adversely affect the operation of the pretensioner.

A second aspect of the present disclosure provides a seat belt retractor as an eighth mode of the disclosure, the seat belt retractor including: a housing including a pair of opposed side walls; a winding drum on which a webbing is wound, the winding drum being located between the pair of side walls and rotatable in a winding direction for winding of the webbing and in a pull-out direction for pull-out of the webbing; a locking base located in a first axial direction relative to the winding drum, the first axial direction being one of opposite axial directions of the winding drum, the locking base being configured to be prevented from rotating in the pull-out direction in a vehicle emergency; an impact energy absorbing member including a first end and a second end, coupled to the winding drum at or near the first end and to the locking base at or near the second end, and configured to, under a normal state, connect the winding drum and the locking base such that the winding drum and the locking base are rotatable together, the impact energy absorbing member being further configured to, in case that a pull-out force applied to the webbing exceeds a predetermined level while rotation of the locking base in the pull-out direction is prevented, plastically deform to absorb impact energy while permitting relative rotation between the winding drum and the locking base; an impact energy absorbing wire received in a slot located in the winding drum, the slot having an opening facing in the first axial direction, the impact energy absorbing wire including a head portion protruding from the opening of the slot and attached to the locking base, the impact energy absorbing wire being configured to, during relative rotation between the winding drum and the locking base, be pulled out from the opening of the slot while plastically deforming to absorb impact energy; and a cap member mounted on the locking base or the winding drum, wherein the head portion of the impact energy absorbing wire extends through the locking base in a second axial direction opposite to the first axial direction, and the cap member includes a cover portion configured to contact the head portion of the impact energy absorbing wire to prevent the impact energy absorbing wire from being displaced from the slot.

In the above configuration, the cap member mounted on the locking base or the winding drum includes the cover portion that contacts the head portion of the impact energy absorbing wire to prevent the impact energy absorbing wire from being displaced from the slot of the winding drum. Accordingly, the impact energy absorbing wire can be reliably retained in the slot of the winding drum. Furthermore, the cover portion may be always in contact with the head portion of the impact energy absorbing wire; in this case, noise caused by vibration of the head portion of the impact energy absorbing wire can be suppressed. In addition, a sufficient length of the impact energy absorbing wire can be retained in the slot of the winding drum. Accordingly, during relative rotation between the winding drum and the locking base, the impact energy absorbing wire is pulled out from the opening of the slot to a sufficient amount while plastically deforming, thereby reliably absorbing impact energy.

In a seat belt retractor according to a ninth mode based on the eighth mode, the cap member may include an outer wall portion covering an outer peripheral surface of a drum end of the winding drum that is located in the first axial direction, the cover portion may be connected to a first outer wall end of the outer wall portion that is located in the first axial direction, the drum end of the winding drum may be located in a through hole extending through one of the side walls that is located in the first axial direction among the side walls, and the outer wall portion of the cap member may be located in the through hole. In this configuration, the end of the winding drum does not directly contact the inner peripheral surface of the through hole even when the winding drum is displaced relative to the housing in a vehicle emergency. Furthermore, the cap member may be made of a material having better sliding properties with respect to metals than sliding between metals; in this case, the sliding resistance between the winding drum and the housing can be reduced when the winding drum is displaced relative to the housing.

In a seat belt retractor according to a tenth mode based on the ninth mode, the cap member may include a claw projecting inward in a radial direction of the winding drum from a second outer wall end of the outer wall portion that is located in the second axial direction, the claw being engaged with the drum end of the winding drum. In this configuration, the cap member can be easily mounted to the winding drum and can be retained on the winding drum by engagement of the claw.

What is claimed is:

1. A seat belt retractor comprising:
a housing including a pair of opposed side walls;
a winding drum on which a webbing is wound, the winding drum being located between the pair of side walls and rotatable in a winding direction for winding of the webbing and in a pull-out direction for pull-out of the webbing;
a holding member located in a first axial direction relative to the winding drum and rotatable relative to the winding drum, the first axial direction being one of opposite axial directions of the winding drum;
a locking base mounted on the holding member, rotatable together with the holding member, and configured to be prevented from rotating in the pull-out direction in a vehicle emergency;
an impact energy absorbing member including a first end and a second end, coupled to the winding drum at or near the first end and to the locking base at or near the second end, and configured to, under a normal state, connect the winding drum and the locking base such that the winding drum and the locking base are rotatable together, the impact energy absorbing member being further configured to, in case that a pull-out force applied to the webbing exceeds a predetermined level while rotation of the locking base in the pull-out direction is prevented, plastically deform to absorb impact energy while permitting relative rotation between the winding drum and the locking base;
an impact energy absorbing wire received in a slot located in the winding drum, the slot having an opening facing in the first axial direction, the impact energy absorbing wire including a head portion protruding from the opening of the slot and attached to the holding member, the impact energy absorbing wire being configured to, during relative rotation between the winding drum and the locking base, be pulled out from the opening of the slot while plastically deforming to absorb impact energy; and
a cap member mounted on the holding member or the winding drum, wherein
the head portion of the impact energy absorbing wire extends through the holding member in a second axial direction opposite to the first axial direction, and
the cap member includes a cover portion configured to contact the head portion of the impact energy absorbing wire to prevent the impact energy absorbing wire from being displaced from the slot.

2. The seat belt retractor according to claim 1, wherein
the cap member includes an outer wall portion covering an outer peripheral surface of a drum end of the winding drum that is located in the first axial direction,
the cover portion is connected to a first outer wall end of the outer wall portion that is located in the first axial direction,
the drum end of the winding drum is located in a through hole extending through one of the side walls that is located in the first axial direction among the side walls, and
the outer wall portion of the cap member is located in the through hole.

3. The seat belt retractor according to claim 2, wherein
the cap member includes a first claw projecting inward in a radial direction of the winding drum from a second outer wall end of the outer wall portion that is located in the second axial direction, the first claw being engaged with the drum end of the winding drum.

4. The seat belt retractor according to claim 1, wherein
the drum end of the winding drum that is located in the first axial direction includes a tubular rib into which the holding member is inserted,
the cap member includes an inner wall portion located between the holding member and the rib, and
the cover portion is connected to a first inner wall end of the inner wall portion that is located in the first axial direction.

5. The seat belt retractor according to claim 4, wherein
the cap member includes a second claw projecting inward in a radial direction of the winding drum from a second inner wall end of the inner wall portion that is located in the second axial direction, the second claw being engaged with the holding member.

6. The seat belt retractor according to claim 1, further comprising a pretensioner configured to, in a vehicle emergency, rotate the holding member to rotate the winding drum in the winding direction via the locking base and the impact energy absorbing member.

7. The seat belt retractor according to claim 6, wherein
the holding member includes engagement teeth on an outer periphery of the holding member,
the pretensioner includes a movable member that moves during operation of the pretensioner, the movable member being configured to, while moving, engage with the engagement teeth to rotate the holding member,
the holding member includes a flange portion located in a portion of the holding member extending from the engagement teeth toward the winding drum, and
the head portion of the impact energy absorbing wire is attached to the flange portion.

8. A seat belt retractor comprising:
a housing including a pair of opposed side walls;
a winding drum on which a webbing is wound, the winding drum being located between the pair of side walls and rotatable in a winding direction for winding of the webbing and in a pull-out direction for pull-out of the webbing;
a locking base located in a first axial direction relative to the winding drum, the first axial direction being one of opposite axial directions of the winding drum, the locking base being configured to be prevented from rotating in the pull-out direction in a vehicle emergency;
an impact energy absorbing member including a first end and a second end, coupled to the winding drum at or near the first end and to the locking base at or near the second end, and configured to, under a normal state, connect the winding drum and the locking base such that the winding drum and the locking base are rotatable together, the impact energy absorbing member being further configured to, in case that a pull-out force applied to the webbing exceeds a predetermined level while rotation of the locking base in the pull-out direction is prevented, plastically deform to absorb impact energy while permitting relative rotation between the winding drum and the locking base;
an impact energy absorbing wire received in a slot located in the winding drum, the slot having an opening facing in the first axial direction, the impact energy absorbing wire including a head portion protruding from the opening of the slot and attached to the locking base, the impact energy absorbing wire being configured to, during relative rotation between the winding drum and the locking base, be pulled out from the opening of the slot while plastically deforming to absorb impact energy; and
a cap member mounted on the locking base or the winding drum, wherein
the head portion of the impact energy absorbing wire extends through the locking base in a second axial direction opposite to the first axial direction, and
the cap member includes a cover portion configured to contact the head portion of the impact energy absorbing wire to prevent the impact energy absorbing wire from being displaced from the slot.

9. The seat belt retractor according to claim 8, wherein
the cap member includes an outer wall portion covering an outer peripheral surface of a drum end of the winding drum that is located in the first axial direction,
the cover portion is connected to a first outer wall end of the outer wall portion that is located in the first axial direction,
the drum end of the winding drum is located in a through hole extending through one of the side walls that is located in the first axial direction among the side walls, and
the outer wall portion of the cap member is located in the through hole.

10. The seat belt retractor according to claim 9, wherein
the cap member includes a claw projecting inward in a radial direction of the winding drum from a second outer wall end of the outer wall portion that is located in the second axial direction, the claw being engaged with the drum end of the winding drum.
